(19) United States
(12) Patent Application Publication
(10) Pub. No.: US 2025/0295113 A1
(43) Pub. Date: Sep. 25, 2025

(54) COMPOSITION AND METHOD FOR CONTROLLING WEEDS

(71) Applicant: SYNGENTA CROP PROTECTION AG, Basel (CH)

(72) Inventors: John Robert JAMES, Greensboro, NC (US); David PEARSAUL, Vero Beach, FL (US)

(73) Assignee: SYNGENTA CROP PROTECTION AG, Basel (CH)

(21) Appl. No.: 18/864,454

(22) PCT Filed: May 10, 2023
(86) PCT No.: PCT/EP2023/062504

§ 371 Date: Nov. 8, 2024

(30) Foreign Application Priority Data
May 10, 2022 (EP) 22172605.2

(51) Int. Cl. A01N 43/42; A01N 25/32; A01P 13/02

(52) U.S. Cl. CPC A01N 43/42; A01N 25/32; A01P 13/02

(57) ABSTRACT

The present invention relates to a method of controlling weeds in susceptible turfgrass without causing significant injury to the turfgrass, comprising applying to the turfgrass a herbicidally effective amount of quinclorac, or a salt thereof and a safening amount of metcamifen.

The present invention relates to a composition and method for controlling weeds in turf without causing significant injury to the turfgrass. In particular, the invention relates to a composition and method for controlling weeds in St. Augustine grass without causing significant injury to the turfgrass using a composition comprising a herbicidally effective amount of quinclorac and a metcamifen safener.

The need for removal of unwanted plants and other undesirable vegetation such as noxious weeds and invasive plants is a constantly recurring problem in agriculture as well as in landscaped and industrial areas. For example, selectively removing problematic weeds and invasive species from golf courses (greens, fairways, tees, and roughs), sports fields, industrial turfgrass and residential turfgrass is essential for maintaining high quality, healthy turf. Weeds can decrease the quality of turf due to the contrast in colour and texture between the turfgrass plants and the weeds. In addition, weeds compete with the turfgrass plants for available water and nutrients, usually resulting in thinning of desirable turfgrass cover. Accordingly, there exists a need for novel methods to control weeds in turfgrass and to provide high quality, healthy turf.

Quinclorac (3,7-dichloro-8-quinolinecarboxylic acid) (CAS RN: 84087-01-4; EP60429B1) is a synthetic auxin herbicide useful for controlling certain broadleaf and grassy weeds in turfgrass. See also Johnson, Journal of Environmental Horticulture (1994) 12 (2): 83-86. However, quinclorac is phytotoxic to certain susceptible turfgrasses. Quinclorac phytotoxicity is particularly severe when it is applied to control weeds in certain warm season turfgrasses.

Metcamifen (2-Methoxy-N-[[4-[[(methylamino)carbonyl]amino]phenyl]sulfonyl]benzamide) (CAS RN: 129531-12-0; U.S. Pat. No. 5,215,570) is a safener compound useful for protecting cultivated plants against the damaging effect of various selective herbicides. Certain crystalline polymorph forms of the safener metcamifen including Form 1, Form 2 and Form 3 also are known (WO2013/117691).

There remains a need for improved quinclorac weed control compositions and methods in synthetic auxin susceptible turfgrass which reduces the phytotoxicity of quinclorac to such turfgrass.

Surprisingly, it has now been found that the phytotoxic effects of quinclorac can be further reduced when applied in combination with metcamifen for the selective control of unwanted weeds in the presence of susceptible turfgrass, without loss of herbicidal efficacy. In particular, it has been found that the phytotoxic effects of quinclorac, or a salt thereof, can be further reduced when it is applied in combination with metcamifen to selectively control weeds in certain susceptible warm season turfgrass (esp. St. Augustinegrass), without loss of herbicidal efficacy against such weeds.

According to the present invention, there is provided a method of controlling weeds in susceptible turfgrass without causing significant injury to the turfgrass, comprising applying to the turfgrass a herbicidally effective amount of quinclorac, or a salt thereof and an effective amount of metcamifen as safener.

In particular, the present invention comprises selectively controlling unwanted weeds in the presence of a susceptible warm season (C4) turfgrass at a turfgrass locus without causing significant injury to the turfgrass, comprising applying to the turfgrass locus a herbicidally effective amount of quinclorac, or a salt thereof and an effective amount of metcamifen as safener

More specifically, the present invention provides a method of selectively controlling unwanted weeds in the presence of a synthetic auxin susceptible warm season (C4) turfgrass at a turfgrass locus without causing significant injury to the turfgrass and without antagonizing herbicidal efficacy, comprising applying to the turfgrass locus a herbicidally effective amount of quinclorac, or a salt thereof and an effective amount of metcamifen as safener.

The method of present invention is particularly suitable for selectively controlling unwanted weeds in the presence of St. Augustinegrass at a turfgrass locus without causing significant injury to the St. Augustinegrass and without antagonizing herbicidal efficacy, comprising applying to the turfgrass locus a composition comprising a herbicidally effective amount of quinclorac, or a salt thereof and an effective amount of metcamifen as safener.

The present invention also provides a safened herbicidal composition for use in turfgrass susceptible to injury by a synthetic auxin herbicide comprising: a) a herbicidally effective amount of quinclorac, or a salt thereof; and b) an effective safening amount of metcamifen, wherein the safened herbicidal composition is capable of safening the quinclorac, or a salt thereof, to the turfgrass.

The present invention further provides a method for reducing phytotoxicity to warm season (C4) turfgrass such as St. Augustinegrass due to application of a synthetic auxin herbicidal compound such as quinclorac or a salt thereof alone or in admixture with one or more co-herbicidal compounds which comprises applying to the locus of the turfgrass an antidotally-effective amount of metcamifen.

Embodiments according to the method of the invention are provided as set out below.

In one embodiment, quinclorac (3,7-dichloro-8-quinolinecarboxylic acid) is applied or formulated in acid form.

In another embodiment, quinclorac (3,7-dichloro-8-quinolinecarboxylic acid) can be applied or formulated as a salt such as a dimethylamine salt. Unless otherwise specifically stated, reference to quinclorac herein is understood to mean quinclorac acid or a salt thereof.

In one embodiment, a safened herbicidal composition of the invention is suitable for use in turfgrass susceptible to injury by a synthetic auxin herbicide such as quinclorac. The composition comprises: a) a herbicidally effective amount of quinclorac, or a salt thereof; and b) an effective safening amount of metcamifen. The safened herbicidal composition of the present invention is capable of safening the quinclorac, or a salt thereof, to the turfgrass.

In one embodiment, the safened herbicidal composition comprises an aqueous spray composition.

In another embodiment, the weight ratio of (a) quinclorac to (b) metcamifen in the safened herbicidal composition and method is from 1:2 to 450:1; more particularly, from 2:1 to 45:1; preferably, from 35:1 to 3:1. In one preferred embodiment, the weight ratio of (a) quinclorac to (b) metcamifen in the safened herbicidal composition and method is 573:75, or 7.64:1.

In one embodiment, a herbicidally effective amount of quinclorac is applied to the turfgrass at a rate of from 140 to 2240 g ai/ha; more specifically at a rate of from 280 to 1120 g ai/ha; preferably a rate of from 400 to 850 g ai/ha. When quinclorac is applied as a salt, the application rate of the herbicidally effective amount of quinclorac as described above can be expressed as acid equivalent (a.e.) per hectare. In one embodiment, metcamifen as (2-Methoxy-N-[[4-[[(methylamino)carbonyl]amino]phenyl]sulfonyl]benzamide) is used as a safener in the composition or the method of the present invention.

In another embodiment, Metcamifen can be applied or formulated as a crystalline polymorph designated Form 1 as described in WO2013/117691, which is characterised, for example, by a powder X-ray diffraction pattern expressed in terms of 2θ angles, wherein the powder X-ray diffraction pattern comprises at least three, at least four, at least five, at least six, at least 7 or all 2θ angle values (in degrees) selected from the group comprising 7.4±0.2, 9.3±0.2, 11.7±0.2, 12.0±0.2, 14.3±0.2, 15.1±0.2, 17.4±0.2 and 19.0±0.2. Form 1 has a melting point of 198° C.±5° C. This melting point is obtained using Differential Scanning Calorimetry (DSC) with a heating rate of 10° C./minute.

In another embodiment, Metcamifen can be applied or formulated as a crystalline polymorph designated Form 2 as described in WO2013/117691, which is characterised by a powder X-ray diffraction pattern expressed in terms of 2θ angles, wherein the powder X-ray diffraction pattern comprises at least one 2θ angle value at 9.0±0.2; and one 2θ angle value at 21.7±0.2; and at least three, at least four, at least five, at least six or all 2θ angle values selected from the group comprising 7.7±0.2, 11.9±0.2, 13.4±0.2, 15.0±0.2, 15.6±0.2, 16.1±0.2 and 18.0±0.2. Form 2 has a melting point of 216° C.±5° C. This melting point is obtained using Differential Scanning Calorimetry (DSC) with a heating rate of 10° C./minute.

In another embodiment, Metcamifen can be applied or formulated as a crystalline polymorph designated Form 3 as described in WO2013/117691, which is characterised by a powder X-ray diffraction pattern expressed in terms of 2θ angles, wherein the powder X-ray diffraction pattern comprises one 2θ angle value at 16.9±0.2; and one 2θ angle value at 18.9±0.2; and at least three, at least four, at least five, at least six, at least seven, at least eight, at least nine, at least ten or all 2θ angle values selected from the group comprising 7.5±0.2, 12.3±0.2, 13.4±0.2, 14.4±0.2, 14.9±0.2, 15.8±0.2, 18.3±0.2, 20.9±0.2, 21.9±0.2, 22.6±0.2 and 23.8±0.2. Form 3 has a melting point of 202° C.±5° C. This melting point is obtained using Differential Scanning Calorimetry (DSC) with a heating rate of 10° C./minute.

Unless otherwise specifically stated, reference to Metcamifen herein is understood to mean Metcamifen as (2-Methoxy-N-[[4-[[(methylamino)carbonyl]amino]phenyl]sulfonyl]benzamide) or a polymorph (Form 1, Form 2, or Form 3) thereof.

In one embodiment, an effective amount of metcamifen is a safening or antidotally effective amount. Preferably, a safening or antidotally effective amount of metcamifen that is applied to the turfgrass in accordance with the invention at a rate of from 5 to 300 g ai/ha; more specifically at a rate of from 25 to 150 g ai/ha.

In one embodiment, in the method of the invention, the herbicidally effective amount of quinclorac, or a salt thereof and the safening effective amount of metcamifen are applied to the turf locus simultaneously or sequentially. In a preferred embodiment, the quinclorac, or a salt thereof and metcamifen are applied to the turf locus simultaneously; preferably, with a safened herbicidal composition of the invention.

Preferably, in the method of the invention, the quinclorac, or a salt thereof and the metcamifen are applied simultaneously or sequentially to the turf locus by a post-emergence foliar treatment. More preferably, the quinclorac, or a salt thereof and the metcamifen are applied simultaneously to the turf locus by a post-emergence foliar treatment with an aqueous spray composition.

In one embodiment, the quinclorac, or a salt thereof and the metcamifen are applied to the turf locus in an aqueous spray composition. In another embodiment, the aqueous spray volume applied to the turf locus is from 100 to 300 l/ha; Preferably, the water volume of the aqueous spray composition applied to the turf locus is from 150 to 200 l/ha; such as 187 l/ha.

In one embodiment, 1 to 3 post sequential foliar applications of the quinclorac, or a salt thereof and the metcamifen are made to the turf locus on a 7 to 42-day spray schedule or interval; preferably, on 14-day to 21-day intervals.

In one embodiment, in the method of the invention a herbicidally effective amount of quinclorac, or a salt thereof and an effective amount of metcamifen as safener are applied to a turfgrass locus comprising the unwanted broadleaf or grassy weeds to be controlled and the desired synthetic auxin (quinclorac) susceptible warm season (C4) turfgrass species (such as St. Augustinegrass). For example, the term “turfgrass locus” means the area in which both the broad leaf or grassy weeds and the desired synthetic auxin susceptible warm season (C4) turfgrass species have emerged, are growing, or are established such as: golf courses (greens, fairways, tees, and roughs), sports fields, industrial turfgrass, residential turfgrass, amenity grassland or grounds, lawns or turfgrass around airports; cemeteries; commercial establishments and rights of way; houses of worship; military and other institutions; multifamily dwellings; parks; picnic grounds; roadsides; schools; sod farms; and the like. In the context of the present invention, although the turfgrass locus may further comprise other types of plants, weeds or vegetation, the present invention is directed to a method for controlling the unwanted weeds (broadleaf or grassy weeds) that are present in such locus including emerged, growing as well as established vegetation.

The term “susceptible” means a turfgrass species that can be injured by application of the synthetic auxin (quinclorac) due to phytotoxic damage in the absence of metcamifen. For example, injury, in particular a significant or excessive injury, means unacceptable levels of phytotoxicity, bleaching or stunting of the turfgrass, and/or an unacceptable reduction in turfgrass colour and quality. Turfgrass colour and quality is an industry standard assessment, based on a scale of 1 to 9, with 9 indicating dark green colour of turf and the highest quality. Assessments of turfgrass quality are based on several factors, including stunting, uniformity and density of the turf stand. A turfgrass quality of 6 or less is deemed to be unacceptable.

Accordingly, a method for reducing phytotoxicity to warm season (C4) turfgrass such as St. Augustinegrass due to application of a synthetic auxin herbicidal compound such as quinclorac or a salt thereof alone or in admixture with one or more co-herbicidal compounds comprises applying to the locus of the turfgrass an antidotally-effective amount of metcamifen.

Advantageously, in the practice of the invention a herbicide combination comprising quinclorac or a salt thereof and a safener, wherein the safener is metcamifen, is applied to selectively control weeds in turfgrass. Preferably, the combination comprises a herbicidally effective amount of quinclorac and a safening effective amount of metcamifen. The turfgrass is a synthetic auxin (quinclorac) susceptible warm season (C4) turfgrass species (such as St. Augustinegrass). The method for selective weed control in such turfgrass is carried out with reduced phytoxicity/herbicidal injury to the otherwise susceptible turfgrass and without reducing or antagonizing the herbicidal activity of the quinclorac with respect to the target weeds. The weeds to be controlled are broadleaf or grassy weeds; preferably, the weeds to be controlled are crabgrass including blanket crabgrass (Digitaria serotina) and torpedo grass.

In a preferred embodiment of the present invention, the method for selectively controlling unwanted broadleaf or grassy weeds in the presence of synthetic auxin (quinclorac) susceptible warm season (C4) turfgrass species (such as St. Augustinegrass) at a turfgrass locus comprises applying a broadleaf or grassy weed controlling amount of an aqueous spray composition to the turfgrass locus, wherein the composition comprises a herbicidally effective amount of quinclorac, or a salt thereof and an effective amount of metcamifen as safener; wherein the quinclorac is applied to the turfgrass locus at a rate of from 140 to 2240 g ai/ha; more specifically at a rate of from 280 to 1120 g ai/ha; preferably a rate of from 400 to 850 g ai/ha. When a salt of quinclorac is used it is applied at a rate of 140 to 2240 g ae/ha; more specifically at a rate of from 280 to 1120 g ae/ha; preferably a rate of from 400 to 850 g ae/ha.

Suitable weight ratios of the quinclorac and the metcamifen compound are found, for example, by the above-noted application rates for the individual compounds. In one embodiment, mixing ratios of the quinclorac (Q) and the metcamifen (M) compound according to the invention in the inventive method are, for example: Q:M of from 280:75 to 1120:75; or from 10:1 to 120:1. As noted, other ratios will be apparent to those skilled in the art for any given scenario or based on the above-noted application rates and the herbicide concentrations in suitable commercial formulations used to prepare aqueous spray formulations to be used in the method of the invention.

In one embodiment, the quinclorac is in acid form. In another embodiment, the quinclorac is in salt form.

In accordance with the method of the invention, an aqueous spray composition comprising an herbicidally effective amount of quinclorac, or a salt thereof and an effective amount of metcamifen safener can produce a controlling or modifying effect on the growth of broadleaf or grassy weeds growing in the presence of synthetic auxin (quinclorac) susceptible warm season (C4) turfgrass species (such as St. Augustinegrass) at a turfgrass locus. Controlling or modifying effects include all deviation from natural development, for example: killing, retardation, leaf burn, albinism, dwarfing, germination prevention and the like. For example, broadleaf or grassy weeds that are not killed are often stunted and non-competitive with flowering disrupted. The term ‘plants’ refers to all physical parts of a plant, including seeds, seedlings, saplings, roots, tubers, stems, stalks, foliage and fruits.

The aqueous spray composition used in the method of the invention can be prepared on site by the end-user shortly before application to the foliage of the unwanted broadleaf or grassy weeds growing in the presence of the synthetic auxin (quinclorac) susceptible warm season (C4) turfgrass species to be managed or controlled by mixing a quinclorac containing composition with a composition containing metcamifen and, optionally, a suitable surfactant or adjuvant (such as methylated seed oil, or the like). Such compositions are typically referred to as “tank-mix” compositions. Suitable tank mix compositions can be prepared from mixing commercially available compositions of the active components. Examples of suitable commercial quinclorac formulations include: DRIVE XLR8 Herbicide (BASF Corporation) and Quali-Pro Quinclorac 75 DF (Control Solutions, Inc.).

Alternatively, the compositions used in the method of the invention may be provided to the end-user already formulated, at the desired dilution for application (“ready to use” compositions) or supplied in a pre-built concentrate format that requires dilution, dispersion, or dissolution in water by the end-user (“concentrate” compositions). The ready-to-use format is particularly suitable for the consumer market. The concentrate formulation may be used in either the consumer market or the professional market, as well. Such preformulated concentrates can be liquids or particulate solids.

The aqueous spray composition useful in the inventive method is generally formulated in various ways using formulation adjuvants, such as carriers, solvents and surface-active substances. Concentrate compositions can be in various physical forms, e.g. in the form of dusting powders, gels, wettable powders, water-dispersible granules, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). As noted above, such compositions can either be used directly or diluted prior to use by tank mix. The dilutions can be made, for example, with water, liquid fertilisers, micronutrients, biological organisms, oil or solvents.

The aqueous spray compositions can be prepared e.g. by mixing the quinclorac and the metcamifen (“active ingredients”) with the formulation adjuvants in order to obtain compositions in the form of finely divided solids, granules, solutions, dispersions, emulsions microemulsions or suspo-emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

The active ingredients can also be contained in very fine microcapsules. Microcapsules contain the active ingredients in a porous carrier. This enables the active ingredients to be released into the environment in controlled amounts (e.g. slow-release). Microcapsules usually have a diameter of from 0.1 to 500 microns. They contain active ingredients in an amount of about from 25 to 95% by weight of the capsule weight. The active ingredients can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art. Alternatively, very fine microcapsules can be formed in which the active ingredient is contained in the form of finely divided particles in a solid matrix of base substance, but the microcapsules are not themselves encapsulated.

The formulation adjuvants that are suitable for the preparation of the aqueous spray compositions used in the method of the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, N-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surface-active substances can advantageously be used in both solid and liquid formulations, especially in those formulations which can be diluted with a carrier prior to use. Surface-active substances may be anionic, cationic, non-ionic or polymeric and they can be used as emulsifiers, wetting agents or suspending agents or for other purposes. Typical surface-active substances include, for example, salts of alkyl sulfates, such as diethanolammonium lauryl sulfate; salts of alkylarylsulfonates, such as calcium dodecylbenzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters; and also further substances described e.g. in McCutcheon's Detergents and Emulsifiers Annual, MC Publishing Corp., Ridgewood New Jersey (1981).

Further adjuvants that can be used in pesticidal formulations include crystallisation inhibitors, viscosity modifiers, suspending agents, dyes, anti-oxidants, foaming agents, light absorbers, mixing auxiliaries, antifoams, complexing agents, neutralising or pH-modifying substances and buffers, corrosion inhibitors, fragrances, wetting agents, take-up enhancers, micronutrients, plasticisers, glidants, lubricants, dispersants, thickeners, antifreezes, microbicides, and liquid and solid fertilisers.

The compositions according to the invention can include an additive comprising an oil of vegetable or animal origin, a mineral oil, alkyl esters of such oils or mixtures of such oils and oil derivatives. The amount of oil additive in the composition according to the invention is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C₈-C₂₂ fatty acids, especially the methyl derivatives of C₁₂-C₁₈ fatty acids, for example the methyl esters of lauric acid, palmitic acid and oleic acid (methyl laurate, methyl palmitate and methyl oleate, respectively). Many oil derivatives are known from the Compendium of Herbicide Adjuvants, 10th Edition, Southern Illinois University, 2010.

The compositions useful in the method of the invention generally comprise from 0.1 to 99% by weight, especially from 0.1 to 95% by weight, of active ingredients and from 1 to 99.9% by weight of a formulation adjuvant which preferably includes from 0 to 25% by weight of a surface-active substance. Whereas commercial products used for tank mix may preferably be formulated as concentrates, the aqueous spray composition applied by the end user will normally employ dilute formulations.

The aqueous spray composition used in the method is applied as a post-emergence aqueous spray application accomplished in a customary manner (watering, spraying, atomizing), including a post-emergence aqueous foliar spray application. In the context of the present invention, the term “post-emergence” is taken to mean that the spray composition is applied once the target broadleaf or grassy weed has emerged from the turfgrass locus that contains a synthetic auxin (quinclorac) susceptible warm season (C4) turfgrass species. The emerged target broadleaf or grassy weeds will include growing plants and established plants. The quinclorac and the metcamifen compound are applied simultaneously, or may be applied sequentially to the turfgrass locus (in any order). In this instance the components are typically applied within 3 days and most preferably within 24 hours of each other. Suitably, all the components are administered within a timescale of a few hours, such as one hour. Alternatively, and preferably, the individual components are applied simultaneously by aqueous spray application in a single herbicidal aqueous spray composition to a turfgrass locus. If the components are sprayed simultaneously, they may be administered separately or as a tank mix or as a pre-formulated mixture of all the components or as a pre-formulated mixture of some of the components which are then tank mixed with the remaining components.

In a preferred embodiment, the method for controlling unwanted broadleaf or grassy weed at a turfgrass locus comprises applying a broadleaf or grassy weed controlling amount of an aqueous spray composition to the foliage of the unwanted broadleaf or grassy weeds that have emerged, are growing, or are established at a turfgrass locus in the presence of a synthetic auxin (quinclorac) susceptible warm season (C4) turfgrass species (preferably, St. Augustinegrass). The method of the present invention also is useful for the spot treatment of broadleaf or grassy weeds growing at a turfgrass locus, or for clearing all the broadleaf or grassy weeds from a turfgrass locus.

In one embodiment, with respect to a particular turfgrass locus, the method of the present invention can be carried out with an application program comprising 1 to 3 post sequential spray applications on a 7 to 42-day spray schedule; preferably, on 14-day to 21-day intervals.

If desired, the present invention includes the use of mixtures of more than one herbicide, for example to enhance spectrum of weed control. Mesotrione, sulcotrione, benzobicyclon, tembotrione and topramezone (HPPD herbicide chemistry, Triketone) Others include isoxazoles herbicide chemistry—isoxaflutole and isoxachlortole, and pyrazole herbicide chemistry—benxofenap, pyrazolynate and pyrazoxyfen. Dithiopyr and thiazopyr (Pyridine herbicide herbicide) Trifloxysulfuron (Sulfonylurea herbicide chemistry) Trifloxysulfuron is only one of a number of herbicides that act as sulfonylurea herbicides. Other sulfonylurea herbicides include metsulfuron, chlorsulfuron, halosulfuron, foramsulfuron, rimsulfuron, sulfosulfuron and flazasulfuron, iodosulfuron, Examples of imidazolinone herbicide chemistry include imaziquin, imazapyr and imazapic. Examples of triazolopyrimide herbicide chemistry include cloransulam-methyl, florasulam, flumetsulam, penoxsulam. Examples of pyrimidinyl benzoate herbicide chemistry include bispyribac-Na. Examples of sulfonylaminocarbonyl-triazolinone herbicide chemistry include flucarbazone-Na, theincarbazone-methyl. Atrazine and Simazine (Triazine herbicide chemistry). Amicarbazone (Triazinone herbicide chemistry). Siduron (Urea herbicide chemistry) Carfentrazone-ethyl and sulfentrazone (Triazolinone herbicide chemistry). Butafenacil (Pyrimidindione herbicide chemistry). Bentazon (Benzothiadiazinone herbicide chemistry). Isoxaben (Benzamide herbicide chemistry). Indaziflam (Alkylazine herbicide chemistry). Ipfencarbazone (Tetrazolinones herbicide chemistry). Quinclorac (Quinoline carboxylic acid herbicide chemistry). Ethofumesate (Benzofuran herbicide chemistry). 2,4-D, 2,4-DB, MCPP (Phenoxy-carboxylic acid herbicide chemistry). Dicamba (Benzoic Acid herbicide chemistry). Clopyralid, triclopyr and fluroxpyr (Pyridine carboxylic herbicide chemistry). Oxadiazon (Oxadiazole herbicide chemistry). Prodiamine (Dinitroaniline herbicide chemistry), Other DNAs include pendimethalin, trioryzaline and trifluralin. Fluazifop-p-butyl (Aryloxyphenoxy-propionate “FOPS” herbicide chemistry-Fluazifop-p-butyl clodinafop-propargyl, cyhalofop-butyl, diclofop-methyl, fenoxaprop-P-ethyl, haloxyfop-R-methyl, propaquizafop, metamifop and quizalofop-P-ethyl. Examples in Cyclohexanedione “DIMS” herbicide chemistry include alloxydim, butroxydim, clethodim, cycloxydim, profoxydim, sethoxydim, tepraloxydin, tralkoxydim. Glyphosate (Glycine herbicide chemistry)—On native and transgenic turf. Glufosinate-ammonium (Phosphinic herbicide chemistry)—On native and transgenic turf. S-metolachlor and dimethenamid-P (Chloroacetamide herbicide chemistry)

It is also possible to use mixtures of more than one safener in conjunction with metcamifen such as cloquintocet, cyprosulfamide and isoxadifen-ethyl, for example, to enhance selectivity (i.e. to provide reduced injury of the herbicidal composition to a broader range of desirable turfgrass species).

In some cases, herbicidal active ingredients have been shown to be more effective in combination with plant growth regulators (PGRs) than when applied individually. Combinations with the following PGR compounds and groups of PGR chemistry are noted: Plant growth regulators include azole PGR Chemistry (such as uniconazole, and paclobutrazol), cyclohexane carboxylates (such as trinexapac-ethyl, and prohexadione-calcium), pyrimidinyl carbinols (such as flurprimidol, and ancymidol), quarternary ammoniums (such as chlormequat-chloride, and mepiquat-chloride), sulphonyl-amino phenyl-acetamides (such as mefluidide), cycloalkenes (such as 1-methylcyclopropene), and hydrochloride salts (such as aminoethoxyvinylglycine). Plant growth regulators such as trinexapac-ethyl are commonly used on turf to improve turf colour, quality, reduce clipping and improved rooting.

The method of the invention may be used against many unwanted grassy and broadleaf weeds. By way of example, unwanted grassy and broadleaf weeds to be managed or controlled by the method of the invention include grassy weeds such as Barnyardgrass (Echinochloa crusgalli), Large Crabgrass (Digitaria sanguinalis), Smooth Crabgrass (Digitaria ischaemum), Giant Foxtail (Setari faberi), Green Foxtail (Setari viridis), Yellow Foxtail (Setari glauca), Kikuyugrass (Pennisetum clandestinum), Signalgrass, Broadleaf (Brachiaria platyphylla), and Torpedograss (Panicum repens); broadleaf weeds such as Field bindweed (Convolvulus arvensis), Hop Clover (Trifolium aureum Pollich), Red Clover (Trifolium pretense), White Clover (Trifolium repens), English Daisy (Bellis perenne), Common Dandelion (Taraxacum officinale), Dollarweed (Hydrocotyle umbellate), Carolina Geranium (Geranium carolinium), Black Medic (Medicago lupuline), Morningglory spp. (Ipomea sp.), Common Speedwell (Veronica officinalis), Slender Speedwell (Veronica filiformis), Thymeleaf Speedwell (Veronica serpyllifolia), and Wild Violet (Viola sp.). Undesired weeds such as torpedograss and crabgrass are particularly noted.

In one embodiment, the susceptible warm season (C4) turfgrass species include, but are not limited to, Bermudagrasses (Cynodon L. C. Rich), Zoysiagrasses (Zoysia Willd.), St. Augustinegrass (Stenotaphrum secundatum (Walt.) Kuntze), Centipedegrass (Eremochloa ophiuroides (Munro.) Hack.), Buffalograss (Buchloe dactyloides (Nutt.) Engelm.), Seashore paspalum (Paspalum vaginatum). In one embodiment, the warm season (C4) turfgrass species is synthetic auxin (quinclorac) susceptible. Preference is given to St. Augustinegrass.

Various aspects and embodiments of the present invention will now be illustrated in more detail by way of example. It will be appreciated that modification of detail may be made without departing from the scope of the invention.

### EXAMPLES

### Example 1

In a trial conducted on St Augustinegrass variety ‘Floratam’, two formulations of quinclorac (Quinclorac 75 DF and Drive XLR8) were applied at 573 g ai/ha with and without metcamifen applied at 75 g ai/ha. Two applications were applied on a 21-day interval. Quinclorac alone, with both formulations, resulted in significant injury. At 5 weeks after the first application, Drive XLR8 and Quinclorac 75 DF resulted in 73.8% and 28.8% injury, respectively. The addition of metcamifen to each of these products reduced injury to 12.5% and 2.5%, respectively.

| | | | % Floratam Phytotoxicity | | | | | | | | | | | | | | |
|---|---|---|---|---|---|---|---|---|---|---|---|---|---|---|---|---|---|
| | Name | Rate | Unit* | 1 WAA** | | 2 WAA | | 3 WAA | | 4 WAA | | 5 WAA | | 6 WAA | | 8 WAA | |
| 1 | UTC | | | 0 | d*** | 0 | d | 0 | d | 0 | c | 0 | d | 0 | d | 0 | b |
| 2 | DRIVE XLR8 | 573 | g ae/ha | 55 | a | 61.3 | a | 37.5 | a | 47.5 | a | 73.8 | a | 61.3 | a | 25 | a |
| 3 | DRIVE XLR8 | 573 | g ae/ha | 30 | b | 28.8 | b | 13.8 | c | 18.8 | b | 12.5 | c | 12.5 | c | 0 | b |
| | Metcamifen | 75 | g ai/ha | | | | | | | | | | | | | | |
| 4 | QUINCLORAC | 573 | g ai/ha | 30 | b | 28.8 | b | 23.8 | b | 33.8 | a | 28.8 | b | 25 | b | 8.8 | b |
| | 75 DF | | | | | | | | | | | | | | | | |
| 5 | QUINCLORAC | 573 | g ai/ha | 13.8 | c | 13.8 | c | 3.8 | d | 5 | bc | 2.5 | cd | 0 | d | 0 | b |
| | 75 DF | | | | | | | | | | | | | | | | |
| | Metcamifen | 75 | g ai/ha | | | | | | | | | | | | | | |

*g ae/ha = grams acid equivalent per hectare; g ai/ha = grams active ingredient per hectare
**WAA is weeks after application A, the first application.
***LSD P = 0.05

### Example 2

In a second trial on ‘Floratam’ St. Augustinegrass the two quinclorac formulations were again applied at 573 g ai/ha with and without metcamifen applied at 75 g ai/ha. At 6 weeks after the first application, the addition of metcamifen reduced injury from Quinclorac 75 DF from 66.3% down to 12.5%.

| | | | | % Floratam Phytotoxicity | | | | | | | | | | | | | |
|---|---|---|---|---|---|---|---|---|---|---|---|---|---|---|---|---|---|
| | Name | Rate | Unit* | 1 WAA ** | | 2 WAA | | 3 WAA | | 4 WAA | | 5 WAA | | 6 WAA | | 8 WAA | |
| 1 | UTC | | | 0 | c*** | 0 | c | 0 | b | 0 | c | 0 | c | 0 | c | 0 | b |
| 2 | DRIVE XLR8 | 573 | g ae/ha | 37.5 | a | 46.3 | a | 47.5 | a | 67.5 | a | 62.5 | a | 68.8 | a | 37.5 | a |
| 3 | DRIVE XLR8 | 573 | g ae/ha | 21.3 | b | 22.5 | b | 13.8 | b | 27.5 | b | 26.3 | b | 25 | b | 11.3 | b |
| | Metcamifen | 75 | g ai/ha | | | | | | | | | | | | | | |
| 4 | QUINCLORAC | 573 | g ai/ha | 37.5 | a | 43.8 | a | 48.8 | a | 60 | a | 53.8 | a | 66.3 | a | 43.8 | a |
| | 75 DF | | | | | | | | | | | | | | | | |
| 5 | QUINCLORAC | 573 | g ai/ha | 17.5 | b | 15 | bc | 2.5 | b | 15 | bc | 12.5 | bc | 12.5 | bc | 3.8 | b |
| | 75 DF | | | | | | | | | | | | | | | | |
| | Metcamifen | 75 | g ai/ha | | | | | | | | | | | | | | |

*g ae/ha = grams acid equivalent per hectare; g ai/ha = grams active ingredient per hectare
**WAA is weeks after application A, the first application.
***LSD P = 0.05

### Example 3

Quinclorac was applied at 573 g ai/ha with and without metcamifen applied at 75 g ai/ha. Two applications were made on a 21-day interval. Quinclorac provided control of Torpedograss and, more importantly, the addition of metcamifen did not result in reduced efficacy.

| | | | | % Torpedograss control | | | | | | | | | |
|---|---|---|---|---|---|---|---|---|---|---|---|---|---|
| | Name | Rate g ai/ha* | | 1 WAA** | | 2 WAA | | 3 WAA | | 5 WAA | | 6 WAA | |
| 1 | UTC | | | 0 | b*** | 0 | b | 0 | b | 0 | c | 0 | c |
| 2 | DRIVE XLR8 | 573 | g ae/ha | 33.3 | a | 46.7 | a | 51.7 | a | 71.7 | b | 65 | b |
| 3 | DRIVE XLR8 | 573 | g ae/ha | 31.7 | a | 40 | a | 55 | a | 73.3 | ab | 71.7 | ab |
| | Metcamifen | 75 | g ai/ha | | | | | | | | | | |
| 4 | QUINCLORAC | 573 | g ai/ha | 31.7 | a | 43.3 | a | 58.3 | a | 65 | b | 60 | b |
| | 75 DF | | | | | | | | | | | | |
| 5 | QUINCLORAC | 573 | g ai/ha | 30 | a | 50 | a | 60 | a | 71.7 | b | 60 | b |
| | 75 DF | | | | | | | | | | | | |
| | Metcamifen | 75 | g ai/ha | | | | | | | | | | |

*g ae/ha = grams acid equivalent per hectare; g ai/ha = grams active ingredient per hectare
**WAA is weeks after application A, the first application.
***LSD P = 0.05

### Example 4

In a trial conducted on St Augustinegrass variety Floratam, quinclorac was applied at 573 g ai/ha with and without metcamifen applied at 75 g ai/ha. Two applications were made on a 21-day interval. Quinclorac provided excellent, significant control of blanket crabgrass. Quinclorac applied at 573 g ai/ha with and without metcamifen provided greater than 90% blanket crabgrass control.

| | | | | % Blanket crabgrass control | | | | | | | | | |
|---|---|---|---|---|---|---|---|---|---|---|---|---|---|
| | Name | Rate | Unit* | 1 WAA** | | 3 WAA | | 5 WAA | | 8 WAA | | 10 WAA | |
| 1 | UTC | | | 0 | b*** | 0 | b | 0 | b | 0 | b | 0 | b |
| 2 | QUINCLORAC | 573 | g ai/ha | 51.7 | a | 96.7 | a | 100 | a | 100 | a | 100 | a |
| | 75 DF | | | | | | | | | | | | |
| 3 | QUINCLORAC | 573 | g ai/ha | 41.7 | a | 86.7 | a | 96.7 | a | 95 | a | 95 | a |
| | 75 DF | | | | | | | | | | | | |
| | Metcamifen | 75 | g ai/ha | | | | | | | | | | |

*g ae/ha = grams acid equivalent per hectare; g ai/ha = grams active ingredient per hectare
**WAA is weeks after application A, the first application.
***LSD P = 0.05

These data demonstrate how effective and novel the herbicidal safening is with metcamifen on St Augustine without losing weed control (weed antagonism).

1. A method of selectively controlling weeds in synthetic auxin susceptible turfgrass, comprising applying to the turfgrass a herbicidally effective amount of quinclorac, or a salt thereof and a safening amount of metcamifen.

2. The method according to claim 1, which comprises selectively controlling unwanted weeds in the presence of a susceptible warm season (C4) turfgrass at a turfgrass locus, comprising applying to the turfgrass locus a herbicidally effective amount of quinclorac, or a salt thereof and a safening amount of metcamifen.

3. The method according to claim 1, which comprises selectively controlling unwanted weeds in the presence of St. Augustinegrass at a turfgrass locus without antagonizing herbicidal efficacy, comprising applying to the turfgrass locus a composition comprising a herbicidally effective amount of quinclorac, or a salt thereof and an safening amount of metcamifen.

4. The method according to claim 1, wherein quinclorac is applied in acid form.

5. The method according to claim 1, wherein quinclorac is applied or formulated as a salt such as a dimethylamine salt.

6. The method according to claim 1, wherein quinclorac is applied to the turfgrass locus at a rate of from 140 to 2240 g ai/ha or 140 to 2240 g ae/ha.

7. The method according to claim 1, wherein metcamifen is applied to the turfgrass locus as (2-Methoxy-N-[[4-[[(methylamino)carbonyl]amino]phenyl]sulfonyl]benzamide).

8. The method according to claim 1, wherein metcamifen is applied or formulated as a crystalline polymorph designated Form 1.

9. The method according to claim 1, wherein metcamifen is applied or formulated as a crystalline polymorph designated Form 2.

10. The method according to claim 1, wherein metcamifen is applied or formulated as a crystalline polymorph designated Form 3.

11. The method according to claim 1, wherein metcamifen is applied to the turfgrass locus at a rate of from 5 to 300 g ai/ha.

12. The method according to claim 1, wherein quinclorac and metcamifen are applied to the turfgrass locus by a post-emergence foliar treatment.

13. The method according to claim 1, wherein quinclorac and metcamifen are applied to the turfgrass locus in an aqueous spray composition.

14. The method according to claim 13, wherein the aqueous spray volume applied to the turf locus is from 100 to 300 l/ha.

15. The method according to claim 1, wherein the susceptible turfgrass is warm season (C4) turfgrass species selected from Bermudagrasses (Cynodon L. C. Rich), Zoysiagrasses (Zoysia Willd.), St. Augustinegrass (Stenotaphrum secundatum (Walt.) Kuntze), Centipedegrass (Eremochloa ophiuroides (Munro.) Hack.), Buffalograss (Buchloe dactyloides (Nutt.) Engelm.), Seashore paspalum (Paspalum vaginatum).

16. The method according to claim 15, wherein the susceptible turfgrass is St. Augustinegrass.

17. The method according to claim 1, wherein the unwanted weed is selected from grassy weeds such as Barnyardgrass (Echinochloa crusgalli), Large Crabgrass (Digitaria sanguinalis), Smooth Crabgrass (Digitaria ischaemum), blanket crabgrass (Digitaria serotina), Giant Foxtail (Setari faberi), Green Foxtail (Setari viridis), Yellow Foxtail (Setari glauca), Kikuyugrass (Pennisetum clandestinum), Signalgrass, Broadleaf (Brachiaria platyphylla), and Torpedograss (Panicum repens); broadleaf weeds such as Field bindweed (Convolvulus arvensis), Hop Clover (Trifolium aureum Pollich), Red Clover (Trifolium pretense), White Clover (Trifolium repens), English Daisy (Bellis perenne), Common Dandelion (Taraxacum officinale), Dollarweed (Hydrocotyle umbellate), Carolina Geranium (Geranium carolinium), Black Medic (Medicago lupuline), Morningglory spp. (Ipomea sp.), Common Speedwell (Veronica officinalis), Slender Speedwell (Veronica filiformis), Thymeleaf Speedwell (Veronica serpyllifolia), and Wild Violet (Viola sp.).

18. The method according to claim 17, wherein the undesired weed is selected from torpedograss and crabgrass.

19. A safened herbicidal composition for use in turfgrass susceptible to injury by a synthetic auxin herbicide comprising: a) a herbicidally effective amount of quinclorac, or a salt thereof; and b) an effective safening amount of metcamifen, wherein the safened herbicidal composition is capable of safening the quinclorac, or a salt thereof, to the turfgrass.

20. A method for reducing phytotoxicity to warm season (C4) turfgrass such as St. Augustinegrass due to application of a synthetic auxin herbicidal compound such as quinclorac or a salt thereof alone or in admixture with one or more co-herbicidal compounds comprises applying to the locus of the turfgrass an antidotally-effective amount of metcamifen.
